(19) United States
(12) Patent Application Publication
(10) Pub. No.: US 2024/0380063 A1
(43) Pub. Date: Nov. 14, 2024

(54) ENERGY STORAGE SYSTEMS

(71) Applicant: Enphase Energy, Inc., Petaluma, CA (US)

(72) Inventor: Chris Morrow YOUNG, Round Rock, TX (US)

(21) Appl. No.: 18/638,869

(22) Filed: Apr. 18, 2024

Related U.S. Application Data
(60) Provisional application No. 63/465,596, filed on May 11, 2023.

(51) Int. Cl. H01M 50/358; H01M 10/42; H01M 10/613; H01M 10/6551; H01M 50/209; H01M 50/298; H01M 50/519; H02J 3/38

(52) U.S. Cl. CPC H01M 50/358; H01M 10/425; H01M 10/613; H01M 10/6551; H01M 50/209; H01M 50/298; H01M 50/519; H02J 3/381; H01M 2010/4271

(57) ABSTRACT

The present disclosure provides an energy storage system. For example, an energy storage system comprises a monolithically formed chassis configured to house a battery cell and having defined thereon at least one of a vent/vapor channel or cooling fins, wherein the vent/vapor channel is defined in an interior of the chassis and is configured for fluid communication with a valve assembly to allow vented gas to pass through the vent/vapor channel and out of the chassis, and wherein the cooling fins are defined on an exterior of the chassis and are configured to provide at least one of active or passive cooling.

### CROSS-REFERENCE TO RELATED APPLICATIONS

The present application claims the benefit of and priority to U.S. Provisional Application Ser. No. 63/465,596, filed on May 11, 2023, the entire contents of which is incorporated herein by reference.

### BACKGROUND

### Field of the Disclosure

Embodiments of the present disclosure relate generally to energy storage systems, and, for example, to energy storage systems comprising a cell enclosure.

### Description of the Related Art

Energy storage systems configured for use with energy management systems are known. For example, cell-to-system designs can use an enclosure (e.g., a metal chassis) for reducing cost and simplifying an assembling process. In such designs, one or more battery cells, e.g., prismatic cells, can be transported to and secured in the metal chassis. Such chassis, however, are still relatively expensive, and may not provide adequate cell venting and/or electrical interconnects.

Accordingly, there is a need for improved energy storage systems comprising a cell enclosure.

### SUMMARY

Energy storage systems are provided herein. For example, in accordance with at least some aspects of the disclosure an energy storage system comprises a monolithically formed chassis configured to house a battery cell and having defined thereon at least one of a vent/vapor channel or cooling fins, wherein the vent/vapor channel is defined in an interior of the chassis and is configured for fluid communication with a valve assembly to allow vented gas to pass through the vent/vapor channel and out of the chassis, and wherein the cooling fins are defined on an exterior of the chassis and are configured to provide at least one of active or passive cooling.

In accordance with at least some aspects of the disclosure an energy management system comprises a distributed energy resource comprising a power conditioner connected to a distributed energy resource controller and an energy storage system connected to the power conditioner and comprising a monolithically formed chassis configured to house a battery cell and having defined thereon at least one of a vent/vapor channel or cooling fins, wherein the vent/vapor channel is defined in an interior of the chassis and is configured for fluid communication with a valve assembly to allow vented gas to pass through the vent/vapor channel and out of the chassis, and wherein the cooling fins are defined on an exterior of the chassis and are configured to provide at least one of active or passive cooling.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure; and

FIG. 2 is a diagram of chassis configured for use with the energy management system of FIG. 1, in accordance with one or more embodiments of the present disclosure.

### DETAILED DESCRIPTION

Embodiments of the present disclosure relate to improved energy storage systems comprising a cell enclosure. For example, in at least some embodiments, an energy storage system comprises a monolithically formed chassis configured to house a battery cell and having defined thereon at least one of a vent/vapor channel or cooling fins, wherein the vent/vapor channel is defined in an interior of the chassis and is configured for fluid communication with a valve assembly to allow vented gas to pass through the vent/vapor channel and out of the chassis, and wherein the cooling fins are defined on an exterior of the chassis and are configured to provide at least one of active or passive cooling. Unlike conventional apparatus, the cell enclosures described herein are relatively inexpensive to manufacture, provides a robust mechanical housing for packaging one or more cells for storage applications, and provides a mechanism for cell venting, and electrical interconnects.

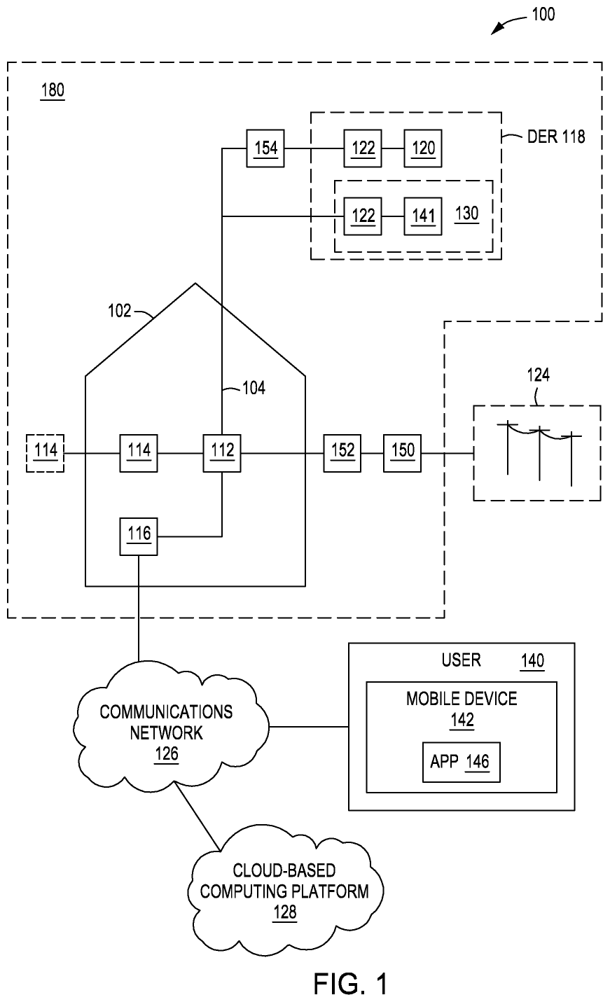

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries convert AC power from the AC bus 104 to DC power for charging the batteries. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (KVAR). The generation meter 154 may communicate the measured values to the DER controller 116, for example using PLC, other types of wired communications, or wireless communication. Additionally, battery charge/discharge values are received through other networking protocols from the AC battery 130.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

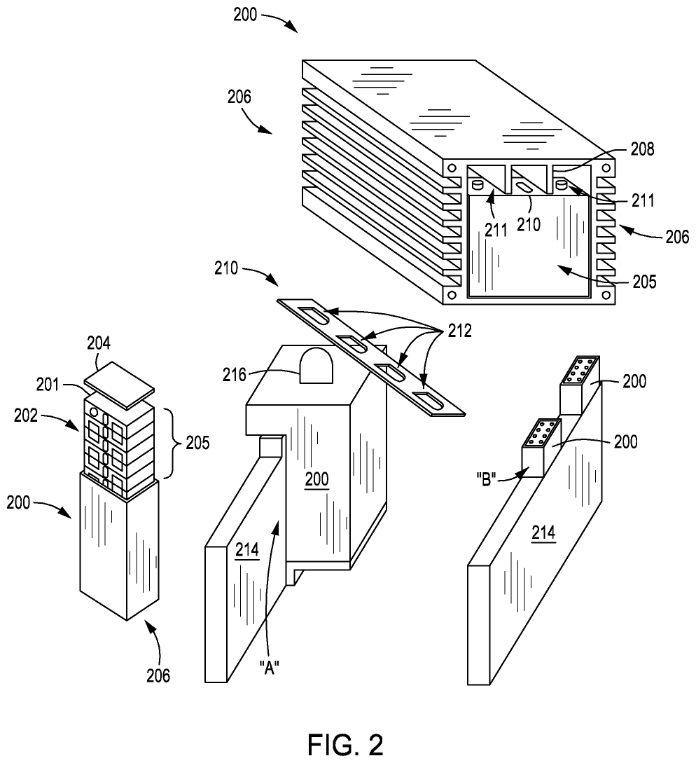

FIG. 2 is a diagram of chassis 200 configured for use with the energy management system of FIG. 1, in accordance with one or more embodiments of the present disclosure. For example, the chassis 200 can be configured for use with one or more energy storage devices (e.g., the energy storage system 114), such as the storage system disclosed in commonly-owned U.S. patent application Ser. No. 17/145,793, filed Jan. 11, 2021 and entitled “Storage System Configured For Use With An Energy Management System,” the entire contents of which is incorporated herein by reference.

The chassis 200 can be configured to house one or more types of battery pack configurations. For example, the chassis 200 can be configured to house prismatic battery packs, cylindrical battery packs, and/or pouch battery packs. For illustrative purposes, the chassis 200 is described configured for use with prismatic battery packs (e.g., a prismatic battery pack 202). For example, the prismatic battery pack 202 comprises one or more battery cells 205 (e.g., 1, 2, 3, 4, etc. battery cells), which can be connected in series via a bus bar (not shown). In at least some embodiments, the prismatic battery pack 202 can comprise up to twelve battery cells, sometimes more.

The chassis 200 can be made/formed from one or more suitable materials. In at least some embodiments, the chassis 200 can be made from an extrusion of plastic and/or metal (e.g., a monolithically formed chassis or components that are extruded and subsequently welded or otherwise joined together). Thus, forming the chassis 200 via the extrusion process provides an easy and inexpensive manner to form features on the chassis 200 to accept, for example, screws (or other tightening apparatus) which can be tightened to a predetermined force to compress the one or more battery cells, which can facilitate extending the operational life of the prismatic battery pack 202 (e.g., the one or more battery cells need to compress to provide a long cycle life). Additionally, springs, foam pads, or other suitable apparatus can be disposed within the chassis 200 and located between the end cells (e.g., an end cell 201) and end plates (e.g., end plates 204, one of which is shown in the drawings) and can be used to ensure a substantially constant force is applied to and over the life of the one or more battery cells 205.

The chassis 200 can also be embedded with features to facilitate cooling the one or more battery cells 205. For example, one or more fins 206 (cooling fins) can be formed on an outside (e.g., exterior) of the extrusion (the chassis 200) to provide a larger surface area for passive and/or active cooling. Given that the cooling efficiency is generally a function of the surface area, a larger surface area provides better cooling. For example, a surface area of twice the area would be expected to provide around twice the cooling capability of a smaller surface area.

A vent/vapor channel 208 is defined through a length of the extrusion (the chassis 200) to direct vented gases to exit through the end plates 204. For example, the vent/vapor channel 208 is configured to be in fluid communication with a valve assembly 210, which allows the vented gases to exist in a corresponding vented battery cell while sealing off other battery cells from being substantially exposed to vented gases. For example, the valve assembly is provided within the vent/vapor channel 208 and can be disposed between the top of the one or more battery cells 205 and the bottom of the vent/vapor channel 208. In at least some embodiments, the valve assembly 210 can be a thin sheet of metal (plastic, ceramic, etc.) which has cut-outs 212 that act as valves to steer the vented gases. Thus, when a battery cell(s) of the one or more battery cells 205 vents due to an abnormal condition (fault), gases leave the battery cell through the vent/vapor channel 208 located at the top of the battery cell. For example, as the gas exits a battery cell, the gas pushes on vent flaps (not shown), which cover corresponding cut-outs, on the valve assembly 210 to force the vent flaps into the vent/vapor channel 208. For example, the vent flaps are configured to rise (extend) into the vent/vapor channel 208 and block the vented gases from traveling backwards in the vent/vapor channel 208 so that the vented gases pass through the vent/vapor channel 208 in a preferred direction. In the preferred direction, the other battery cells of the one or more battery cells 205 are shielded from the vented gases by the vent flaps that are positioned over the battery cells that remain closed. In at least some embodiments, one or more other channels can be also included in the extrusion to facilitate, for example, wiring, or tubing.

In at least some embodiments, between the vent/vapor channel 208 and the walls (e.g., a sidewalls) that define the vent/vapor channel 208 can be a space 211 above the one or more battery cells 205 where the one or more battery cells 205 can be connected electrically to/with at least one of cables or printed circuit boards, e.g., with appropriate traces for conducting current. The traces, for example, can contain current restricted areas to provide integrated fusing in case of high current faults.

The end plates 204 are configured to connect to opposite ends of the chassis 200 via one or more fastening apparatus (e.g., screw, bolts, etc.) for receiving the one or more battery cells 205 (e.g., so that the one or more battery cells 205 can slid into the chassis 200) and enclosing the one or more battery cells 205 within chassis 200. In at least some embodiments, the end plates 204 can comprise one or more features for securing the chassis 200 to a mounting or wiring rail 214. In at least some embodiments, the one or more features can include, but is not limited to, screws, nuts and bolts, clamps, or other suitable fastening apparatus for connecting the chassis 200 to the mounting or wiring rail 214. Additionally, the end plates 204 can comprise one or more electrical connectors for connecting to the chassis 200 and/or directly to the one or more battery cells 205. In at least some embodiments, the chassis 200 can be mounted on the mounting or wiring rail 214 in a relatively vertical orientation (see “A” in FIG. 2). For example, mounting the chassis 200 in the relatively vertical orientation facilitates operation of the cooling channels, e.g., the cooling channels are more efficient when mounted vertically. Alternatively, the chassis 200 can be mounted on the mounting or wiring rail 214 in a relatively horizontal orientation (see “B” in FIG. 2). For example, mounting the chassis 200 in the relatively horizontal orientation facilitates connecting the one or more electrical connectors (e.g., on the end plate 204) of the chassis 200 with integrated wiring on the mounting or wiring rail 214 (e.g., for plug-and-play functionality).

A lifting structure 216 can be provided on one or more of the end plates 204 to facilitate mounting the chassis 200 to the mounting or wiring rail 214. In at least some embodiments, the lifting structure 216 can be configured for grasping by a hand of a user.

The chassis 200 can be configured to house one or more types of separating material (or compression material, e.g., aerogel, silicon rubber, polymer nanocomposites, etc. not shown) that can be provided/disposed between the one or more battery cells 205 and interior walls of the chassis 200. The separating material can be configured to provide a predetermined amount of separation between the one or more battery cells 205 and the interior walls of the chassis 200.

Additionally, as noted above, the chassis 200 can be configured to house or support (e.g., inside the space 211) one or more printed circuit board assemblies ((PCBA), not shown) that can be configured to connect/disconnect to the one or more battery cells 205, e.g., via the appropriate traces for conducting current. In at least some embodiments, voltage (V) and temperature (T) sensing components on the PCBA can connect to battery tabs on the one or more battery cells 205 via screw or welding. The one or more PCBA can be configured to provide battery status information (V and T) to a battery management unit/system (BMU/S) which could be on a PCU (not shown). For example, the V and T sensing components allow the one or more PCBA to sense voltage and temperature and/or current of the one or more battery cells 205.

While the foregoing is directed to embodiments of the present disclosure, other and further embodiments of the disclosure may be devised without departing from the basic scope thereof, and the scope thereof is determined by the claims that follow.

What is claimed is:

1. An energy storage system, comprising:
a monolithically formed chassis configured to house a battery cell and having defined thereon at least one of a vent/vapor channel or cooling fins, wherein the vent/vapor channel is defined in an interior of the chassis and is configured for fluid communication with a valve assembly to allow vented gas to pass through the vent/vapor channel and out of the chassis, and wherein the cooling fins are defined on an exterior of the chassis and are configured to provide at least one of active or passive cooling.

2. The energy storage system of claim 1, wherein the vent/vapor channel is configured to allow vent flaps on the valve assembly to extend into the vent/vapor channel and block the vented gas from traveling backwards in the vent/vapor channel so that the vented gas passes through the vent/vapor channel in a preferred direction.

3. The energy storage system of claim 1, wherein between the vent/vapor channel and walls that define the vent/vapor channel is a space above the battery cell to accommodate at least one of cables or printed circuit boards for connecting to the battery cell.

4. The energy storage system of claim 1, wherein the chassis further comprises end plates that are configured to connect to opposite ends of the chassis for receiving and enclosing the battery cell within chassis.

5. The energy storage system of claim 4, wherein the end plates of the chassis are configured to mount on a mounting or wiring rail.

6. The energy storage system of claim 5, wherein the end plates of the chassis are configured to mount on the mounting or wiring rail in a vertical orientation.

7. The energy storage system of claim 5, wherein the end plates of the chassis are configured to mount on the mounting or wiring rail in a horizontal orientation.

8. An energy management system, comprising:
a distributed energy resource comprising a power conditioner connected to a distributed energy resource controller; and
an energy storage system connected to the power conditioner and comprising a monolithically formed chassis configured to house a battery cell and having defined thereon at least one of a vent/vapor channel or cooling fins,
wherein the vent/vapor channel is defined in an interior of the chassis and is configured for fluid communication with a valve assembly to allow vented gas to pass through the vent/vapor channel and out of the chassis, and
wherein the cooling fins are defined on an exterior of the chassis and are configured to provide at least one of active or passive cooling.

9. The energy management system of claim 8, wherein the vent/vapor channel is configured to allow vent flaps on the valve assembly to extend into the vent/vapor channel and block the vented gas from traveling backwards in the vent/vapor channel so that the vented gas passes through the vent/vapor channel in a preferred direction.

10. The energy management system of claim 8, wherein between the vent/vapor channel and walls that define the vent/vapor channel is a space above the battery cell to accommodate at least one of cables or printed circuit boards for connecting to the battery cell.

11. The energy management system of claim 8, wherein the chassis further comprises end plates that are configured to connect to opposite ends of the chassis for receiving and enclosing the battery cell within chassis.

12. The energy management system of claim 11, wherein the end plates of the chassis are configured to mount on a mounting or wiring rail.

13. The energy management system of claim 12, wherein the end plates of the chassis are configured to mount on the mounting or wiring rail in a vertical orientation.

14. The energy management system of claim 12, wherein the end plates of the chassis are configured to mount on the mounting or wiring rail in a horizontal orientation.
